(19) United States
(12) Patent Application Publication
(10) Pub. No.: US 2021/0192934 A1
(43) Pub. Date: Jun. 24, 2021

(54) REMOTE CONTROL COMMAND TRANSMISSION METHOD, REMOTE CONTROL DEVICE, MOBILE PLATFORM, AND STORAGE MEDIUM

(71) Applicant: SZ DJI TECHNOLOGY CO., LTD., SHENZHEN (CN)

(72) Inventors: Ning MA, Shenzhen (CN); Ying CHEN, Shenzhen (CN); Zhipeng ZHANG, Shenzhen (CN)

(21) Appl. No.: 17/190,370

(22) Filed: Mar. 2, 2021

Related U.S. Application Data
(63) Continuation of application No. PCT/CN2018/108432, filed on Sep. 28, 2018.

(51) Int. Cl. G08C 17/02

(52) U.S. Cl. CPC G08C 17/02; G08C 2201/50

(57) ABSTRACT

A remote control command transmission method includes obtaining remote control command transmission instruction information and transmitting a target remote control command to a mobile platform according to the transmission instruction information. The target remote control command includes a basic remote control command or a compressed remote control command. The basic remote control command includes an original remote control command. The compressed remote control command includes a remote control command generated based on a current original remote control command detected at a current moment and a previous original remote control command detected before the current moment.

### CROSS-REFERENCE TO RELATED APPLICATION

This application is a continuation of International Application No. PCT/CN2018/108432, filed Sep. 28, 2018, the entire content of which is incorporated herein by reference.

### TECHNICAL FIELD

The present disclosure relates to the field of electronic technology and, more particularly, to a remote control command transmission method, a remote control device, a mobile platform and a storage medium.

### BACKGROUND

Generally, an operator can control a movement of a mobile platform through a joystick or a button of a remote control device. The specific principle is that the remote control device determines a remote control command according to the operator's operation on the operation device, where the remote control command includes a moving direction, moving speed and other information of the mobile platform, and then transmits the remote control command to the mobile platform so that the mobile platform moves according to the remote control command.

Practice has shown that whether the remote control command is successfully transmitted usually depends on the quality of a remote control link. When the quality of the remote control link is poor, for example, there exist some problems such as serious interference of the link signal from an unlicensed channel, serious link signal attenuation caused by an obstruction and multipath effect caused by a rapid movement of a remote terminal, and an overly long communication distance, the remote control command is usually not successfully transmitted to the mobile platform. Therefore, how to better transmit remote control commands has become a research hotspot.

### SUMMARY

In accordance with the disclosure, there is provided a remote control command transmission method including obtaining remote control command transmission instruction information and transmitting a target remote control command to a mobile platform according to the transmission instruction information. The target remote control command includes a basic remote control command or a compressed remote control command. The basic remote control command includes an original remote control command. The compressed remote control command includes a remote control command generated based on a current original remote control command detected at a current moment and a previous original remote control command detected before the current moment.

Also in accordance with the disclosure, there is provided a remote control device including a memory storing program instructions and a processor configured to execute the program instructions to obtain remote control command transmission instruction information and transmit a target remote control command to a mobile platform according to the transmission instruction information. The target remote control command includes a basic remote control command or a compressed remote control command. The basic remote control command includes an original remote control command. The compressed remote control command includes a remote control command generated based on a current original remote control command detected at a current moment and a previous original remote control command detected before the current moment.

Also in accordance with the disclosure, there is provided a mobile platform including a body, a power system disposed at the body to provide power for the mobile platform, a memory storing program instructions, and a processor configured to execute the program instructions to receive a target remote control command transmitted by a remote control device, verify the target remote control command to obtain a verification result, determining a flag bit according to the verification result, and feeding back the flag bit to the remote control device. The target remote control command includes a basic remote control command or a compressed remote control command. The basic remote control command includes an original remote control command. The compressed remote control command includes a remote control command generated based on a current original remote control command detected at a current moment and a previous original remote control command detected before the current moment.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is an application scenario diagram of a remote control command transmission method according to an embodiment of the present disclosure.

FIG. 2 is a schematic flowchart of a remote control command transmission method according to an embodiment of the present disclosure.

FIG. 3 is a schematic flowchart of a remote control command transmission method according to another embodiment of the present disclosure.

FIG. 4 is a schematic flowchart of a remote control command transmission method according to an embodiment of the present disclosure.

FIG. 5 is a schematic structural diagram of a remote control device according to an embodiment of the present disclosure.

FIG. 6 is a schematic structural diagram of a mobile platform according to an embodiment of the present disclosure.

### DETAILED DESCRIPTION OF THE EMBODIMENTS

A remote control command transmission method is provided according to an embodiment of the present disclosure. The remote control command transmission method can be applied to a remote control device and a mobile platform. The remote control device here may be a remote controller and the mobile platform here may include but is not limited to an unmanned aerial vehicle (UAV), a remote-control boat, a remote-control car, a robot, etc. In the embodiment of the present disclosure, the UAV is used as an example of the mobile platform.

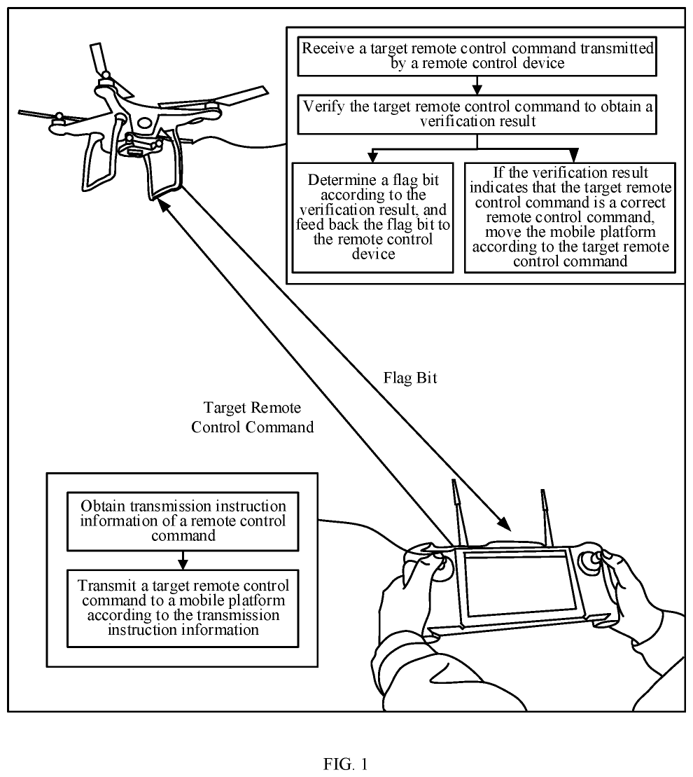

As shown in FIG. 1, an operator can control the UAV to fly through an operation member such as a joystick, a button, or a wheel of a remote control device in the operator's hand. After the remote control device detects an operator's operation command to the operation member, an original remote control command can be determined according to the operation command. The original remote control command refers to a remote control command generated based on an initial position. The original remote control command may include, but is not limited to joystick amount information or wheel information. The joystick amount information may include a push direction and a push amount of the joystick generated by the operator pushing the joystick of the operation member. For example, if the operator pushes the joystick at the initial position 10 degrees to the left, then the joystick amount information is: the push direction of the joystick is to the left and the push amount of the joystick is 10 degrees. The wheel information may include a rolling direction and a rolling amount of the wheel generated by the operator rolling the wheel of the operation member. For example, if the operator rolls the wheel at the initial position twice forward, and each roll of the wheel represents 10 degrees, the wheel information is: the rolling direction is forward, and the rolling amount is 20 degrees.

If the remote control device detects an operator's operation command to the operation member for the first time after an initial startup or a restart after a preset duration of interruption, the remote control device can transmit a basic remote control command to the mobile platform. The basic remote control command is the original remote control command. In the subsequent transmission of the remote control command, the remote control device can obtain transmission instruction information of the remote control command. The transmission instruction information is related to the quality of a remote control link. If the quality of the remote control link is good, the transmission instruction information can be used to instruct to transmit a compressed remote control command to the mobile platform. The compressed remote control command may be a remote control command generated based on an original remote control command detected at a current moment (also referred to as a “current original remote control command”) and an original remote control command detected before the current moment (also referred to as a “previous original remote control command”). If the quality of the remote control link is poor, the transmission instruction information can be used to instruct to transmit a basic remote control command to the mobile platform. Therefore, after obtaining the transmission instruction information, the remote control device can transmit a target remote control command to the mobile platform according to the transmission instruction information, and the target remote control command may include a basic remote control command or a compressed remote control command. In some embodiments, the compressed remote control command may be a difference remote control command generated based on a difference between the original remote control command detected at the current moment and the original remote control command detected before the current moment. For example, if the original remote control command detected at the current moment is “the push direction of the joystick is left, and the push amount of the joystick is 10 degrees” and the original remote control command detected before the current moment is “the push direction of the joystick is left, and the push amount of the joystick is 30 degrees,” the compressed remote control command is “the push amount of the joystick is −20 degrees.” In a specific remote control command, the push amount of the joystick being 30 degrees or −20 degrees refers to a user operation amount corresponding to the original remote control command or the compressed remote control command, and does not refer to an actual configuration of the remote control command. In some embodiments, the remote control command may actually include commands or operations of multiple channels, such as the user's operation of a joystick, a wheel, or a button of the remote control device. During the communication process, the analog signals of these channels can be converted into digital signals and sampled in a certain period. For example, in a model aircraft system, the remote control commands can be sampled at a frequency of 71 Hz, and then are packaged according to a certain protocol format. In this scenario, the basic remote control command includes all the data of the packaged original remote control command. Correspondingly, the compressed remote control command does not directly package all the data of the original remote control command, but package a difference between the original remote control command detected at the current moment and the original remote control command detected before the current moment through a preset algorithm. It should be understood that the “detected before the current moment” here can include the data obtained from the previous sampling, the previous two, three or other samplings, and can also include the data obtained from the multiple previous continuous or non-continuous, interval or non-interval samplings.

When the quality of the remote control link is good, there is generally no remote control command transmission error, that is, the target remote control command is generally a correct remote control command. At this time, the mobile platform can send a flag bit to indicate that the remote control device can transmit a compressed remote control command next time. When the quality of the remote control link is poor, the remote control command transmission error may occur. If the target remote control command is an incorrect remote control command, the mobile platform can send a flag bit to indicate that the remote control device can transmit a basic remote control command next time. Therefore, after receiving the target remote control command transmitted by the remote control device, the mobile platform can verify the target remote control command to obtain a verification result, determine a flag bit according to the verification result, and feedback the flag bit back to the remote control device, so that the remote control device can determine whether to send a basic remote control command or a compressed remote control command next time according to the flag bit. The flag bit is a sign used to indicate whether the target remote control command is a correct remote control command.

After the mobile platform obtains the verification result, if the verification result indicates that the target remote control command is a correct remote control command, the mobile platform can move according to the target remote control command. Specifically, if the target remote control command is a basic remote control command, the mobile platform can be moved directly according to the target remote control command; if the target remote control command is a compressed remote control command, a current original remote control command needs to be generated based on the last original remote control command and the target remote control command, and the mobile platform can be moved according to the generated current original remote control command.

In the embodiments of the present disclosure, when the quality of the remote control link is good, the remote control device can only transmit compressed remote control commands to the mobile platform, which can reduce the transmission content to a certain extent, that is, reduce the transmission data amount (bit), and improve the transmission efficiency of remote control commands. It can be known from a signal-to-noise ratio formula Eb/N0, where Eb is the signal energy per bit of the transmission data and NO is the power spectral density of the noise, that reducing the number of transmission bits can guarantee an increase of the energy per bit, thereby increasing the success rate of remote control command transmission. In addition, the remote control device can also receive the flag bit fed back by the mobile platform, and determine whether to transmit a basic remote control command or a compressed remote control command next time according to the flag bit, which can ensure that a basic remote control command is transmitted to the mobile platform in time when the remote control command transmission error occurs so that the remote control command can be restored quickly to further ensure the reliability of the remote control command transmission.

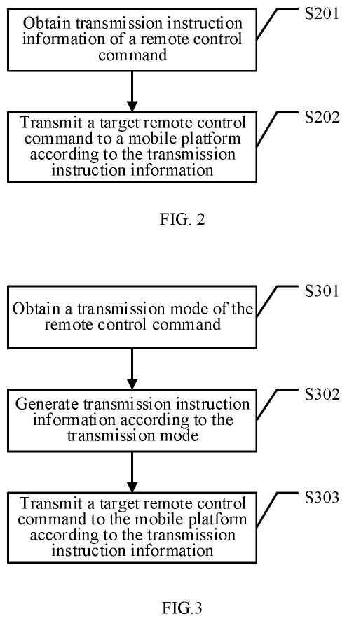

Based on the above description, a remote control command transmission method is provided according to an embodiment of the present disclosure. The remote control command transmission method can be executed by a remote control device. As shown in FIG. 2, the remote control command transmission method includes the following processes of S201-S202.

At S201, transmission instruction information of a remote control command (also referred to as a “remote control command transmission instruction information”) is obtained.

From the above description, it can be seen that the remote control device can transmit a basic remote control command to a mobile platform when transmitting the remote control command for a first time. In the subsequent transmission of the remote control command, the transmission instruction information of the remote control command can be obtained, and then according to the transmission instruction information, it is determined whether to transmit a basic remote control command or a compressed remote control command to the mobile platform.

In some embodiments, the remote control device may obtain the transmission instruction information of the remote control command from the mobile platform, that is, the transmission instruction information may include a flag bit fed back by the mobile platform. The flag bit may include a flag bit for error or a flag bit for being correct. For the convenience of description, the flag bit mentioned later in the embodiments of the present disclosure all takes a flag bit for error as an example.

At S202, a target remote control command is transmitted to the mobile platform according to the transmission instruction information.

The target remote control command includes a basic remote control command or a compressed remote control command. The basic remote control command is an original remote control command. The compressed remote control command is a remote control command generated based on an original remote control command detected at a current moment and an original remote control command detected before the current moment. In some embodiments, the compressed remote control command may be a difference remote control command generated based on a difference between the original remote control command detected at the current moment and the original remote control command detected before the current moment.

In some embodiments, the transmission instruction information includes a flag bit fed back by the mobile platform. Correspondingly, the specific implementation manner of transmitting the target remote control command to the mobile platform according to the transmission instruction information may include determining whether the flag bit is a first identifier or a second identifier, where the first identifier may represent “TRUE” and the second identifier may represent “FALSE.” Because the flag bit is a flag bit for error, when the flag bit is the first identifier “TRUE,” it means that there is a transmission error in the remote control command, and a basic remote control command needs to be transmitted to the mobile platform; when the flag bit is the second identifier “FALSE,” it means that there is no transmission error in the remote control command, and a compressed remote control command can be transmitted to the mobile platform at this time. That is, if the flag bit is the first identifier, the basic remote control command is transmitted to the mobile platform. If the flag bit is the second identifier, the compressed remote control command is transmitted to the mobile platform.

In some embodiments, if the remote control device does not receive the flag bit fed back by the mobile platform within a first preset time length, it can be considered that the quality of the remote control link is poor at this time, which causes the flag bit transmission to fail. At this time, the basic remote control command is transmitted to the mobile platform. Therefore, at S201, the remote control device may also generate transmission instruction information when detecting that the flag bit fed back by the mobile platform is not received within the first preset time length, thereby the transmission instruction information is obtained. That is, the transmission instruction information may be generated when it is detected that the flag bit fed back by the mobile platform is not received within the first preset time length. The transmission instruction information is used to instruct to transmit a basic remote control command to the mobile platform. Correspondingly, at S202, a specific implementation manner of transmitting the target remote control command to the mobile platform according to the transmission instruction information may include transmitting the basic remote control command to the mobile platform.

In the embodiments of the present disclosure, when the remote control command is transmitted, the transmission instruction information of the remote control command may be obtained first, and then the basic remote control command or the compressed remote control command is transmitted to the mobile platform according to the transmission instruction information. Because the compressed remote control command is generated based on the original remote control command detected at the current moment and the original remote control command detected before the current moment, the transmission of the compressed remote control command can reduce the transmission content to a certain extent and reduce the transmission data amount of the remote control command, thereby ensuring the reliability of remote control command transmission, and increasing the success rate of remote control command transmission.

Based on the above description, a remote control command transmission method is provided according to an embodiment of the present disclosure. The remote control command transmission method can be executed by a remote control device. As shown in FIG. 3, the remote control command transmission method includes the following processes of S301-S303.

At S301, a transmission mode of the remote control command (also referred to as a “remote control command transmission mode”) is obtained.

At S302, transmission instruction information is generated according to the transmission mode.

In the processes of S301-S302, in some embodiments, the transmission mode may include a periodic transmission mode, and the transmission instruction information may be used to instruct to periodically transmit the basic remote control commands to the mobile platform at a preset period. Specifically, after the remote control device transmits the basic remote control command to the mobile platform for a first time, in the subsequent transmission process, if the transmission instruction information is not obtained, by default, the compressed remote control command is transmitted to the mobile platform. If the transmission instruction information is obtained when the preset period is reached, the basic remote control command can be transmitted to the mobile platform according to the transmission instruction information.

In some other embodiments, the transmission mode may include another periodic transmission mode. The so-called periodic transmission mode refers to a mode of transmitting basic remote control commands to the mobile platform based on a preset period. Correspondingly, the transmission instruction information includes first transmission instruction information or second transmission instruction information. The first transmission instruction information is used to instruct to transmit the basic remote control command to the mobile platform, and the second transmission instruction information is used to instruct to transmit the compressed remote control command to the mobile platform.

Assuming that a second preset time length of an interval is one cycle, a specific implementation manner of generating transmission instruction information according to the transmission mode may include obtaining a time interval between the moment when the basic remote control command was transmitted last time and the current moment, generating the first transmission instruction information if the time interval reaches the second preset time length, or generating the second transmission instruction information if the time interval does not reach the second preset time length.

At S303, a target remote control command is transmitted to the mobile platform according to the transmission instruction information.

The target remote control command includes a basic remote control command or a compressed remote control command. The basic remote control command is an original remote control command. The compressed remote control command is a remote control command generated based on an original remote control command detected at the current moment and an original remote control command detected before the current moment. In some embodiments, the compressed remote control command may be a difference remote control command generated based on a difference between the original remote control command detected at the current moment and the original remote control command detected before the current moment.

Correspondingly, a specific implementation manner of transmitting the target remote control command to the mobile platform according to the transmission instruction information may include, if the transmission instruction information includes the first transmission instruction information, transmitting the basic remote control command to the mobile platform, and, if the transmission instruction information includes the second transmission instruction information, transmitting the compressed remote control command to the mobile platform.

In the embodiments of the present disclosure, when the remote control command is transmitted, the transmission instruction information of the remote control command may be obtained first, and then the basic remote control command or the compressed remote control command is transmitted to the mobile platform according to the transmission instruction information. Because the compressed remote control command is generated based on the original remote control command detected at the current moment and the original remote control command detected before the current moment, the transmission of the compressed remote control command can reduce the transmission content to a certain extent and reduce the transmission data amount of the remote control command, thereby ensuring the reliability of the remote control command transmission, and increasing the success rate of the remote control command transmission. Moreover, based on the periodic transmission of the basic remote control commands, restoring the remote control commands periodically can be achieved, which further guarantees the reliability of the remote control command transmission to a certain extent.

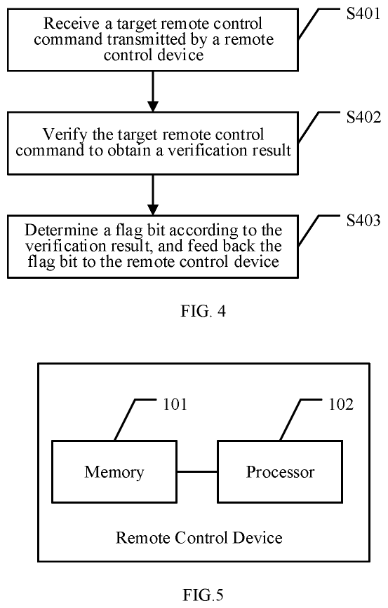

Based on the above description, a remote control command transmission method is provided according to an embodiment of the present disclosure. The remote control command transmission method can be executed by a mobile platform, and the mobile platform here may include, but is not limited to an unmanned aerial vehicle (UAV), a remote-control boat, a remote-control car, a robot, and so on. As shown in FIG. 4, the remote control command transmission method includes the following processes of S401-S403.

At S401, a target remote control command transmitted by a remote control device is received.

The target remote control command includes a basic remote control command or a compressed remote control command. The basic remote control command is an original remote control command. The compressed remote control command is a remote control command generated based on an original remote control command detected at the current moment and an original remote control command detected before the current moment. In some embodiments, the compressed remote control command may be a difference remote control command generated based on a difference between the original remote control command detected at the current moment and the original remote control command detected before the current moment.

At S402, a verification on the target remote control command is performed to obtain a verification result.

When the quality of the remote control link is poor, the cases such as the target remote control command being decoded incorrectly, the target remote control command being missed, or the received remote control command being not continuous, etc. may happen. Therefore, after the target remote control command is received, the target remote control command needs to be verified. In some embodiments, a specific implementation manner for verifying the target remote control command to obtain the verification result may include decoding the target remote control command, if the decoding is correct (i.e., the target remote control command is correctly decoded), determining that the verification result indicates that the target remote control command is a correct remote control command, and if the decoding is incorrect (i.e., the target remote control command is not correctly decoded), determining that the verification result indicates that the target remote control command is an incorrect remote control command.

In some embodiments, a specific implementation manner for verifying the target remote control command to obtain the verification result may include determining whether a difference between the target remote control command and the target remote control command received last time (also referred to as a “previous target remote control command”) satisfies a preset condition, if yes, determining that the verification result indicates that the target remote control command is a correct remote control command, and if no, determining that the verification result indicates that the target remote control command is an incorrect remote control command.

The preset condition may be a condition of checking the continuity of remote control commands. In some embodiments, the preset condition may include that the difference between the target remote control command received each time and the target remote control command received last time should be a fixed value, for example, the fixed value is 10 degrees. Then a specific implementation manner of determining whether the difference between the target remote control command and the target remote control command received last time satisfies the preset conditions may include calculating the difference between the target remote control command and the target remote control command received last time, and determining whether the calculated difference is the fixed value. If yes, it is considered that the preset condition is satisfied; if no, it is considered that the preset condition is not satisfied.

In some embodiments, the preset condition may include that the difference between the target remote control command received each time and the target remote control command received last time should satisfy a preset difference range, for example, the preset difference range is [0, 10]. Then a specific implementation manner of determining whether the difference between the target remote control command and the target remote control command received last time satisfies the preset conditions may include calculating the difference between the target remote control command and the target remote control command received last time, and determining whether the calculated difference satisfies the preset difference range. If yes, it is considered that the preset condition is satisfied; if no, it is considered that the preset condition is not satisfied.

In some embodiments, the preset condition may include that the difference between the target remote control command received each time and the target remote control command received last time should be the same. Then a specific implementation manner of determining whether the difference between the target remote control command and the target remote control command received last time satisfies the preset conditions may include calculating a first difference between the target remote control command and the target remote control command received last time, calculating a second difference between the target remote control command received last time and the target remote control command received the time before last time, and determining whether the first difference and the second difference are same. If yes, it is considered that the preset condition is satisfied; if no, it is considered that the preset condition is not satisfied.

At S403, a flag bit is determined according to the verification result, and the flag bit is fed back to the remote control device.

From the above description, it can be seen that the flag bit may include a flag bit for error or a flag bit for being correct. For the convenience of description, the flag bit mentioned later in the embodiments of the present disclosure all takes a flag bit for error as an example. A specific implementation manner for determining the flag bit according to the verification result may include, if the verification result indicates that the target remote control command is a correct remote control command, setting the flag bit to the second identifier, that is, the second identifier represents “FALSE,” if the verification result indicates that the target remote control command is an incorrect remote control command, determining whether the target remote control command is a basic remote control command, and determining the flag bit according to the determination result.

A specific implementation manner for determining the flag bit according to the determination result may include, if the target remote control command is a basic remote control command, setting the flag bit to the second identifier, and if the target remote control command is not a basic remote control command, setting the flag bit to the first identifier, that is, the first identifier represents “TRUE.”

In some embodiments, when the quality of the remote control link is poor, the transmission of the target remote control command may fail, that is, the mobile platform may not be able to receive the target remote control command. At this time, the mobile platform needs to instruct the remote control device to send the basic remote control command. Therefore, if the target remote control command transmitted by the remote control device is not received within a third preset time length, the flag bit is set to the first identifier, and the flag bit is fed back to the remote control device.

In the embodiments of the present disclosure, when the remote control command is transmitted, the mobile platform can verify the received target remote control command to obtain the verification result, determine the flag bit according to the verification result, and feedback the flag bit to the remote control device, so that the remote control device can determine whether to transmit the basic remote control command or the compressed remote control command to the mobile platform according to the flag bit. Because the compressed remote control command is generated based on the original remote control command detected at the current moment and the original remote control command detected before the current moment, the transmission of the compressed remote control command can reduce the transmission content to a certain extent and reduce the transmission data amount of the remote control command, thereby ensuring the reliability of the remote control command transmission, and increasing the success rate of the remote control command transmission. Moreover, by feeding back the flag bit to the remote control device, the remote control device can restore the target remote control command in time when the target remote control command has a transmission error, thereby ensuring that the mobile platform can move according to the correct remote control command.

Based on the description of the foregoing method embodiments, in an implementation manner, a schematic structural diagram of a remote control device as shown in FIG. 5 is provided according to an embodiment of the present disclosure. As shown in FIG. 5, the remote control device at least includes a memory 101 and a processor 102, where the memory 101 is used to store first program instructions and the processor 102 is configured to call and execute the first program instructions.

In one implementation manner, the processor 102 may be a central processing unit (CPU), and the processor may also be another general-purpose processor, that is, a microprocessor or any conventional processor, such as a digital signal processor (DSP), an application specific integrated circuit (ASIC), a field programmable gate array (FPGA) or other programmable logic device, a discrete gate, a transistor logic device, or a discrete hardware component, etc.

The memory 101 may include a read-only memory and a random access memory, and provides instructions and data to the processor 102. Therefore, the processor 102 and the memory 101 are not limited here.

In some embodiments, the memory 101 is used to store the first program instructions and the processor 102 is configured to call the first program instructions to perform the following processes:

obtaining transmission instruction information of a remote control command;

transmitting a target remote control command to a mobile platform according to the transmission instruction information, where the target remote control command includes a basic remote control command or a compressed remote control command.

The basic remote control command is an original remote control command. The compressed remote control command is a remote control command generated based on an original remote control command detected at a current moment and an original remote control command detected before the current moment.

In one implementation manner, the transmission instruction information includes a flag bit fed back by the mobile platform.

In another implementation manner, when the target remote control command is transmitted to the mobile platform according to the transmission instruction information, the processor 102 is configured to call the first program instructions to perform the following processes:

determining whether the flag bit is a first identifier or a second identifier;

if the flag bit is the first identifier, transmitting the basic remote control command to the mobile platform;

if the flag bit is the second identifier, transmitting the compressed remote control command to the mobile platform.

In another implementation manner, the transmission instruction information is generated when it is detected that the flag bit fed back by the mobile platform is not received within a first preset time length; and

the transmission instruction information is used to instruct to transmit the basic remote control command to the mobile platform.

In another implementation manner, when the transmission instruction information of the remote control command is obtained, the processor 102 is configured to call the first program instructions to perform the following processes:

obtaining a transmission mode of the remote control command;

generating transmission instruction information according to the transmission mode.

In another implementation manner, the transmission mode includes a periodic transmission mode, and the transmission instruction information is used to instruct to periodically transmit the basic remote control commands to the mobile platform at a preset period.

In another implementation manner, the transmission mode includes another periodic transmission mode and the transmission instruction information includes first transmission instruction information or second transmission instruction information;

where the first transmission instruction information is used to instruct to transmit the basic remote control command to the mobile platform, and the second transmission instruction information is used to instruct to transmit the compressed remote control command to the mobile platform.

In another implementation manner, when the transmission instruction information is generated according to the transmission mode, the processor 102 is configured to call the first program instructions to perform the following processes:

obtaining a time interval between the moment when the basic remote control command was transmitted last time and the current moment;

generating the first transmission instruction information if the time interval reaches a second preset time length; or

generating the second transmission instruction information if the time interval does not reach the second preset time length.

In the embodiments of the present disclosure, when the remote control command is transmitted, the transmission instruction information of the remote control command may be obtained first, and then the basic remote control command or the compressed remote control command is transmitted to the mobile platform according to the transmission instruction information. Because the compressed remote control command is generated based on the original remote control command detected at the current moment and the original remote control command detected before the current moment, the transmission of the compressed remote control command can reduce the transmission content to a certain extent and reduce the transmission data amount of the remote control command, thereby ensuring the reliability of the remote control command transmission, and increasing the success rate of the remote control command transmission. Moreover, based on the periodic transmission of the basic remote control commands, restoring the remote control commands periodically can be achieved, which further guarantees the reliability of the remote control command transmission to a certain extent.

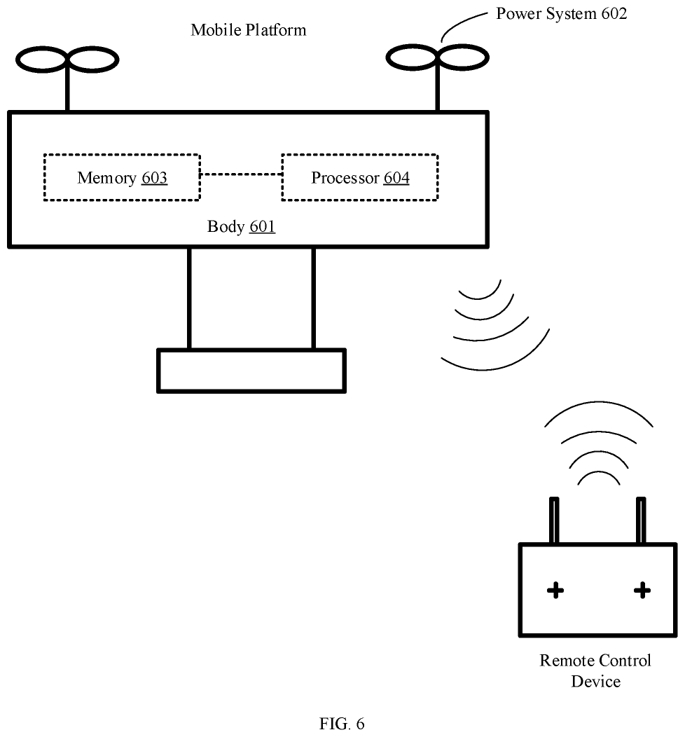

Based on the description of the foregoing method embodiment, in an implementation manner, a schematic structural diagram of a mobile platform as shown in FIG. 6 is provided according to an embodiment of the present disclosure, and the mobile platform can communicate with the remote control device. As shown in FIG. 6, the mobile platform at least includes a body 601, a power system 602, a memory 603, and a processor 604, where the power system is disposed at the body to provide power to the mobile platform, the memory 603 is used to store second program instructions, and the processor 604 is configured to call and execute the second program instructions. Both the memory 603 and the processor 604 are disposed at the body.

In one implementation manner, the processor 604 may be a central processing unit (CPU), and the processor may also be another general-purpose processor, that is, a microprocessor or any conventional processor, such as a digital signal processor (DSP), an application specific integrated circuit (ASIC), a field programmable gate array (FPGA) or other programmable logic device, a discrete gate, a transistor logic device, or a discrete hardware component, etc.

The memory 603 may include a read-only memory and a random access memory, and provides instructions and data to the processor 604. Therefore, the processor 604 and the memory 603 are not limited here.

In one embodiment, the memory 603 is used to store the second program instructions and the processor 604 is configured to call the second program instructions to perform the following processes:

receiving a target remote control command transmitted by a remote control device, where the target remote control command includes a basic remote control command or a compressed remote control command, the basic remote control command is an original remote control command, and the compressed remote control command is a remote control command generated based on an original remote control command detected at the current moment and an original remote control command detected before the current moment;

verifying the target remote control command to obtain a verification result; and

determining a flag bit according to the verification result, and feeding back the flag bit to the remote control device.

In one implementation manner, when the target remote control command is verified to obtain the verification result, the processor 604 is configured to call the second program instructions to perform the following processes:

decoding the target remote control command;

if the decoding is correct, determining that the verification result indicates that the target remote control command is a correct remote control command; and

if the decoding is incorrect, determining that the verification result indicates that the target remote control command is an incorrect remote control command.

In another implementation manner, when the target remote control command is verified to obtain the verification result, the processor 604 is configured to call the second program instructions to perform the following processes:

determining whether a difference between the target remote control command and the target remote control command received last time satisfies a preset condition;

if yes, determining that the verification result indicates that the target remote control command is a correct remote control command; and

if no, determining that the verification result indicates that the target remote control command is an incorrect remote control command.

In another implementation manner, when the flag bit is determined according to the verification result, the processor 604 is configured to call the second program instructions to perform the following processes:

if the verification result indicates that the target remote control command is a correct remote control command, setting the flag bit to a second identifier;

if the verification result indicates that the target remote control command is an incorrect remote control command, determining whether the target remote control command is a basic remote control command; and

determining the flag bit according to the determination result.

In another implementation manner, when the flag bit is determined according to the determination result, the processor 604 is configured to call the second program instructions to perform the following processes:

if the target remote control command is a basic remote control command, setting the flag bit to the second identifier; and

if the target remote control command is not a basic remote control command, setting the flag bit to a first identifier.

In another implementation manner, the processor 604 is configured to call the second program instructions to perform the following processes:

if the target remote control command transmitted by the remote control device is not received within a third preset time length, setting the flag bit to the first identifier.

In another implementation manner, the mobile platform includes any one of a UAV, a remote-control boat, a remote-control car, or a robot.

In the embodiments of the present disclosure, when the remote control command is transmitted, the mobile platform can verify the received target remote control command to obtain the verification result, determine the flag bit according to the verification result, and feedback the flag bit to the remote control device, so that the remote control device can determine whether to transmit the basic remote control command or the compressed remote control command to the mobile platform according to the flag bit. Because the compressed remote control command is generated based on the original remote control command detected at the current moment and the original remote control command detected before the current moment, the transmission of the compressed remote control command can reduce the transmission content to a certain extent and reduce the transmission data amount of the remote control command, thereby ensuring the reliability of the remote control command transmission, and increasing the success rate of the remote control command transmission. Moreover, by feeding back the flag bit to the remote control device, the remote control device can restore the target remote control command in time when the target remote control command has a transmission error, thereby ensuring that the mobile platform can move according to the correct remote control command.

It should be noted that, for the specific working process of the mobile platform and the remote control device described above, reference may be made to the relevant description in the foregoing embodiments, which are not be repeated here.

A person of ordinary skill in the art can understand that all or part of the processes in the above-described embodiment methods can be implemented by instructing relevant hardware through a computer program. The program can be stored in a computer readable storage medium. When the program is executed, the procedures of the above-described method embodiments can be included. The storage medium may be a magnetic disk, an optical disc, a read-only memory (ROM), or a random access memory (RAM), etc. That is, a computer storage medium is further provided according to an embodiment of the present disclosure. The computer storage medium stores first computer program instructions, and the first computer program instructions is suitable for being loaded by a processor and performing the remote control command transmission method shown in FIG. 2 or 3. Or the computer storage medium stores second computer program instructions, and the second computer program instructions is suitable for being loaded by a processor and performing the remote control command transmission method shown in FIG. 4.

The above-disclosed are only part of the embodiments of the present disclosure, which cannot limit the scope of the present disclosure. Those of ordinary skill in the art can understand all or part of the processes for implementing the above-described embodiments and make equivalent changes in accordance with the claims of the present disclosure, which shall still fall within the scope of the disclosure.

What is claimed is:

1. A remote control command transmission method comprising:
obtaining remote control command transmission instruction information; and
transmitting a target remote control command to a mobile platform according to the transmission instruction information, the target remote control command includes:
a basic remote control command including an original remote control command; or
a compressed remote control command including a remote control command generated based on a current original remote control command detected at a current moment and a previous original remote control command detected before the current moment.

2. The method of claim 1, wherein the transmission instruction information includes a flag bit fed back by the mobile platform.

3. The method of claim 2, wherein transmitting the target remote control command to the mobile platform according to the transmission instruction information includes:
determining whether the flag bit is a first identifier or a second identifier;
in response to the flag bit being the first identifier, transmitting the basic remote control command to the mobile platform; and
in response to the flag bit being the second identifier, transmitting the compressed remote control command to the mobile platform.

4. The method of claim 1, wherein:
obtaining the transmission instruction information including generating the transmission instruction information in response to not receiving a flag bit from the mobile platform within a preset time length; and
transmitting the target remote control command to the mobile platform according to the transmission instruction information includes transmitting the basic remote control command to the mobile platform.

5. The method of claim 1, wherein obtaining the transmission instruction information includes:
obtaining a remote control command transmission mode; and
generating the transmission instruction information according to the transmission mode.

6. The method of claim 5, wherein:
the transmission mode includes a periodic transmission mode; and
transmitting the target remote control command to the mobile platform according to the transmission instruction information includes periodically transmitting the basic remote control commands to the mobile platform at a preset period.

7. A remote control device comprising:
a memory storing program instructions; and
a processor configured to execute the program instructions to:
obtain remote control command transmission instruction information; and
transmit a target remote control command to a mobile platform according to the transmission instruction information, the target remote control command includes:
a basic remote control command including an original remote control command; or
a compressed remote control command including a remote control command generated according to a current original remote control command detected at a current moment and a previous original remote control command detected before the current moment.

8. The remote control device of claim 7, wherein the transmission instruction information includes a flag bit fed back by the mobile platform.

9. The remote control device of claim 7, wherein the processor is further configured to execute the program instructions to:
determine whether the flag bit is a first identifier or a second identifier;
in response to the flag bit being the first identifier, transmit the basic remote control command to the mobile platform; and
in response to the flag bit being the second identifier, transmit the compressed remote control command to the mobile platform.

10. The remote control device of claim 7, wherein:
the transmission instruction information is generated in response to not receiving a flag bit from the mobile platform within a preset time length; and
the transmission instruction information is configured to instruct to transmit the basic remote control command to the mobile platform.

11. The remote control device of claim 7, wherein the processor is further configured to execute the program instructions to:
obtain a remote control command transmission mode; and
generate the transmission instruction information according to the transmission mode.

12. The remote control device of claim 11, wherein:
the transmission mode includes a periodic transmission mode; and
the transmission instruction information is configured to instruct to periodically transmit the basic remote control commands to the mobile platform at a preset period.

13. The remote control device of claim 11, wherein the transmission mode includes a periodic transmission mode, and the transmission instruction information includes:
first transmission instruction information configured to instruct to transmit the basic remote control command to the mobile platform; or
second transmission instruction information configured to instruct to transmit the compressed remote control command to the mobile platform.

14. The remote control device of claim 13, wherein the processor is further configured to execute the program instructions to:
obtain a time interval between a moment when the basic remote control command was transmitted last time and the current moment;
generate the first transmission instruction information in response to the time interval reaching a preset time length; and
generate the second transmission instruction information in response to the time interval not reaching the preset time length.

15. A mobile platform comprising:
a body;
a power system disposed at the body to provide power for the mobile platform;
a memory storing program instructions; and
a processor configured to execute the program instructions to:
receive a target remote control command transmitted by a remote control device, the target remote control command including:
a basic remote control command including an original remote control command; or
a compressed remote control command including a remote control command generated according to a current original remote control command detected at a current moment and a previous original remote control command detected before the current moment;
verify the target remote control command to obtain a verification result;
determining a flag bit according to the verification result; and
feeding back the flag bit to the remote control device.

16. The mobile platform of claim 15, wherein the processor is further configured to execute the program instructions to:
decode the target remote control command;
in response to the target remote control command being correctly decoded, determine that the verification result indicates that the target remote control command is a correct remote control command; and
in response to the target remote control command being not correctly decoded, determine that the verification result indicates that the target remote control command is an incorrect remote control command.

17. The mobile platform of claim 15, wherein the processor is further configured to execute the program instructions to:
determine whether a difference between the target remote control command and a previous target remote control command received last time satisfies a preset condition;
in response to the difference satisfying the preset condition, determine that the verification result indicates that the target remote control command is a correct remote control command; and
in response to the difference not satisfying the preset condition, determine that the verification result indicates that the target remote control command is an incorrect remote control command.

18. The mobile platform of claim 15, wherein the processor is further configured to execute the program instructions to:
in response to the verification result indicates that the target remote control command is a correct remote control command, setting the flag bit to an identifier; and
in response to the verification result indicates that the target remote control command is an incorrect remote control command:
determine whether the target remote control command is the basic remote control command; and
determine the flag bit according to the determination result.

19. The mobile platform of claim 18, wherein:
the identifier is a first identifier; and
the processor is further configured to execute the program instructions to:
in response to the target remote control command being the basic remote control command, set the flag bit to the first identifier; and
in response to the target remote control command not being the basic remote control command, set the flag bit to a second identifier.

20. The mobile platform of claim 15, wherein the processor is further configured to execute the program instructions to:
in response to not receiving the target remote control command transmitted by the remote control device within a preset time length, set the flag bit to an identifier.
